(19) United States
(12) Patent Application Publication
(10) Pub. No.: US 2015/0250195 A1
(43) Pub. Date: Sep. 10, 2015

(54) Method and System for Improving Yogurt Texture During Yogurt Manufacture

(71) Applicant: South Dakota Board of Regents, Pierre, SD (US)

(72) Inventors: Hasmukh Patel, Brookings, SD (US); Lloyd Metzger, Bruce, SD (US); Gopinathan Meletharayil, Brookings, SD (US)

(21) Appl. No.: 14/616,952

(22) Filed: Feb. 9, 2015

Related U.S. Application Data
(60) Provisional application No. 61/936,960, filed on Feb. 7, 2014.

(51) Int. Cl. A23C 9/13; A23C 9/12

(52) U.S. Cl. CPC A23C 9/1322; A23C 9/1223

(57) ABSTRACT

A method for improving yogurt texture in a yogurt manufacture process includes providing a volume of milk, injecting carbon dioxide (CO₂) at a selected injection pressure into the provided volume of milk to establish a selected pH level in the provided volume of milk, storing the CO₂-injected milk at a selected temperature for a selected time period, forming a retentate by applying a filtration process to the CO₂-injected milk, mixing the retentate with a volume of non-treated milk to form a mixture of retentate and non-treated milk in a selected proportion and forming a yogurt product with the mixture of retentate and non-treated milk.

### CROSS-REFERENCE TO RELATED APPLICATION

The present application claims the benefit under 35 U.S.C. §119(e) of U.S. Provisional Application Ser. No. 61/936,960, filed Feb. 7, 2014, entitled METHOD AND SYSTEM FOR IMPROVING YOGURT TEXTURE DURING YOGURT MANUFACTURE, naming Hasmukh Patel, Llyod Metzger and Gopinathan Meletharayil as inventors, which is incorporated herein by reference in the entirety.

### TECHNICAL FIELD

The present disclosure generally relates to the field of dairy product manufacture, and, in particular, the manufacture of yogurt with improved texture.

### BACKGROUND

Proteins are the structural building blocks of fermented foods, such as yogurts, which are produced by the lactic fermentation of heated milk. Traditionally, the texture and viscosity of yogurt may be controlled in various manners, such as standardization of milk by adding protein and/or fat content, heat treatment, the use of binding agents and/or the replacement of milk calcium with sodium. Prior methods of texture and viscosity control in yogurt products are limited. As such, it would be desirable to provide an improved method of forming yogurt products.

### SUMMARY

A method for improving yogurt texture in a yogurt manufacture process is disclosed, in accordance with an illustrative embodiment of the present invention. In one illustrative embodiment, the method includes providing a volume of milk. In another illustrative embodiment, the method includes injecting carbon dioxide (CO₂) at a selected injection pressure into at least a portion of the provided volume of milk to establish a selected pH level in the provided volume of milk. In another illustrative embodiment, the method includes storing the CO₂-injected portion of the milk at a selected temperature for a selected time period. In another illustrative embodiment, the method includes forming a retentate by applying a filtration process to the CO₂-injected portion of the milk. In another illustrative embodiment, the method includes mixing at least a portion of the retentate with a volume of non-treated milk to form a mixture of retentate and non-treated milk in one or more selected proportions. In another illustrative embodiment, the method includes forming a yogurt product with at least a portion of the mixture of retentate and non-treated milk. In addition, a yogurt product prepare by the foregoing process is disclosed.

An additional method for improving yogurt texture in a yogurt manufacture process is disclosed, in accordance with an illustrative embodiment of the present invention. In one illustrative embodiment, the method includes providing a volume of milk. In another illustrative embodiment, the method includes injecting CO₂ at a selected injection pressure into at least a portion of the provided volume of milk to establish a selected pH level in the provided volume of milk. In another illustrative embodiment, the method includes storing the CO₂-injected portion of the milk at a selected temperature for a selected time period. In another illustrative embodiment, the method includes mixing the CO₂-injected portion of the milk with a volume of non-treated milk to form a mixture of the CO₂-injected milk and non-treated milk in one or more selected proportions. In another illustrative embodiment, the method includes forming a yogurt product with at least a portion of the mixture of the CO₂-injected milk and non-treated milk. In addition, a yogurt product prepare by the foregoing process is disclosed.

An additional method for improving yogurt texture in a yogurt manufacture process is disclosed, in accordance with an illustrative embodiment of the present invention. In one illustrative embodiment, the method includes providing a volume of milk. In another illustrative embodiment, the method includes injecting CO₂ at a selected injection pressure into at least a portion of the provided volume of milk to establish a selected pH level in the provided volume of milk. In another illustrative embodiment, the method includes storing the CO₂-injected portion of the milk at a selected temperature for a selected time period. In another illustrative embodiment, the method includes forming a retentate by applying a filtration process to the CO₂-injected portion of the milk. In another illustrative embodiment, the method includes forming a yogurt product with at least a portion of the retentate. In addition, a yogurt product prepared by the foregoing process is disclosed.

An additional method for improving yogurt texture in a yogurt manufacture process is disclosed, in accordance with an illustrative embodiment of the present invention. In one illustrative embodiment, the method includes providing a volume of milk. In another illustrative embodiment, the method includes injecting carbon dioxide (CO₂) at a selected injection pressure into at least a portion of the provided volume of milk. In another illustrative embodiment, the method includes applying a filtration process to the at least a portion of the provided volume of milk during the injection of carbon dioxide into the at least a portion of the provided volume of milk to form retentate. In one illustrative embodiment, the carbon dioxide is continuously injected into the milk during the application of a filtration process to the milk. In one illustrative embodiment, the carbon dioxide is periodically injected into the milk during the application of a filtration process to the milk. In another illustrative embodiment, the method includes forming a yogurt product with at least a portion of the retentate. In addition, a yogurt product prepared by the foregoing process is disclosed.

A system for making yogurt is disclosed, in accordance with an illustrative embodiment of the present invention. In one illustrative embodiment, the system includes a milk source. In another illustrative embodiment, the system includes a CO₂ source. In another illustrative embodiment, the system includes a storage unit. In another illustrative embodiment, the system includes a first valve unit arranged to selectively fluidically couple the milk source, the CO₂ source and the storage unit. In another illustrative embodiment, the first valve unit is configured to inject CO₂ from the CO₂ source into milk from the milk source at a selected injection pressure to establish a selected pH level in the milk. In another illustrative embodiment, the storage unit is configured to store a CO₂-injected portion of the milk at a selected temperature for a selected time period. In another illustrative embodiment, a filtration unit is fluidically coupled to the storage unit and configured to form a retentate by applying a filtration process to at least some of the CO₂-injected milk. In another illustrative embodiment, a second valve unit is arranged to selectively fluidically couple at least the milk source and the filtration unit. In another illustrative embodiment, the second valve unit is configured to mix at least a portion of the retentate with non-treated milk from the milk source to form a mixture of retentate and non-treated milk at a selected proportion.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIG. 1A is a block diagram view of a system for making yogurt, in accordance with one embodiment of the present disclosure.

FIG. 1B is a block diagram view of a system for making yogurt, in accordance with one embodiment of the present disclosure.

FIG. 1C is a block diagram view of a system for making yogurt, in accordance with one embodiment of the present disclosure.

FIG. 1D is a block diagram view of a system for making yogurt, in accordance with one embodiment of the present disclosure.

FIG. 1E is a process flow diagram depicting a method for improving yogurt texture in a yogurt manufacture process, in accordance with one embodiment of the present disclosure.

FIG. 1F is a process flow diagram depicting a method for improving yogurt texture in a yogurt manufacture process, in accordance with one embodiment of the present disclosure.

FIG. 1G is a process flow diagram depicting a method for improving yogurt texture in a yogurt manufacture process, in accordance with one embodiment of the present disclosure.

FIG. 1H is a process flow diagram depicting a method for improving yogurt texture in a yogurt manufacture process, in accordance with one embodiment of the present disclosure.

FIG. 2 illustrates the effect of replacing non-treated milk protein with CO₂ treated milk protein on the elastic moduli G′ of the product yogurt, in accordance with one embodiment of the present disclosure.

FIG. 3 illustrates the effect of replacing non-treated milk protein with CO₂-treated milk protein on the gelation time of the product yogurt, in accordance with one embodiment of the present disclosure.

FIG. 4 illustrates the effect of replacing non-treated milk protein with CO₂-treated milk protein on the gelation pH of the product yogurt, in accordance with one embodiment of the present disclosure.

FIGS. 5A and 5B illustrate the dependence of the buffering index on pH, which is modified by CO₂-treatment, in accordance with one embodiment of the present disclosure.

FIG. 6 illustrates a series of apparent viscosity profiles for a series of yogurt as a function of shear rate, in accordance with one embodiment of the present disclosure.

FIG. 7A illustrates the consistency coefficient measured for a series of control and FMP-substituted samples of set yogurt, in accordance with one embodiment of the present disclosure.

FIG. 7B illustrates the apparent viscosity measured at 70 S⁻¹ for a series of control and FMP-substituted samples of set yogurt, in accordance with one embodiment of the present disclosure.

FIG. 7C illustrates the hardness g measured for a series of control and FMP-substituted samples of set yogurt, in accordance with one embodiment of the present disclosure.

FIG. 8 illustrates the effects of different casein-to-whey ratios on the elastic modulus of Greek-style yogurt, in accordance with one embodiment of the present disclosure.

FIG. 9 illustrates the effects of standardizing the milk protein used to manufacture Greek-style yogurt with CO₂ treated milk protein concentrate, in accordance with one embodiment of the present disclosure.

### DETAILED DESCRIPTION

Reference will now be made in detail to the subject matter disclosed, which is illustrated in the accompanying drawings.

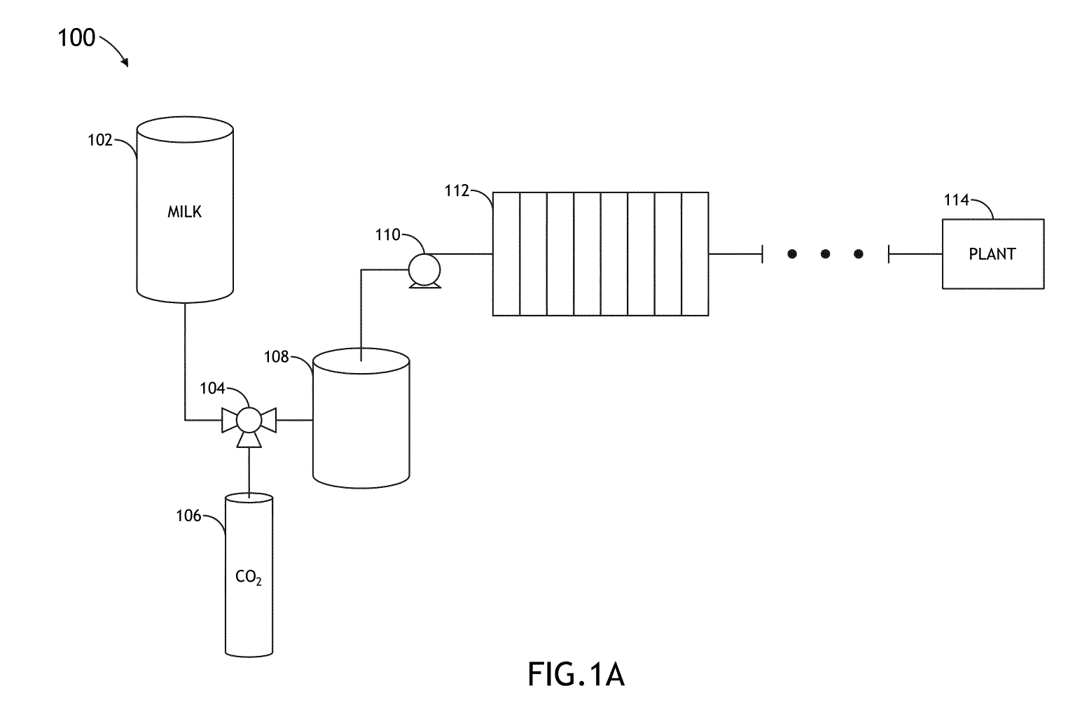

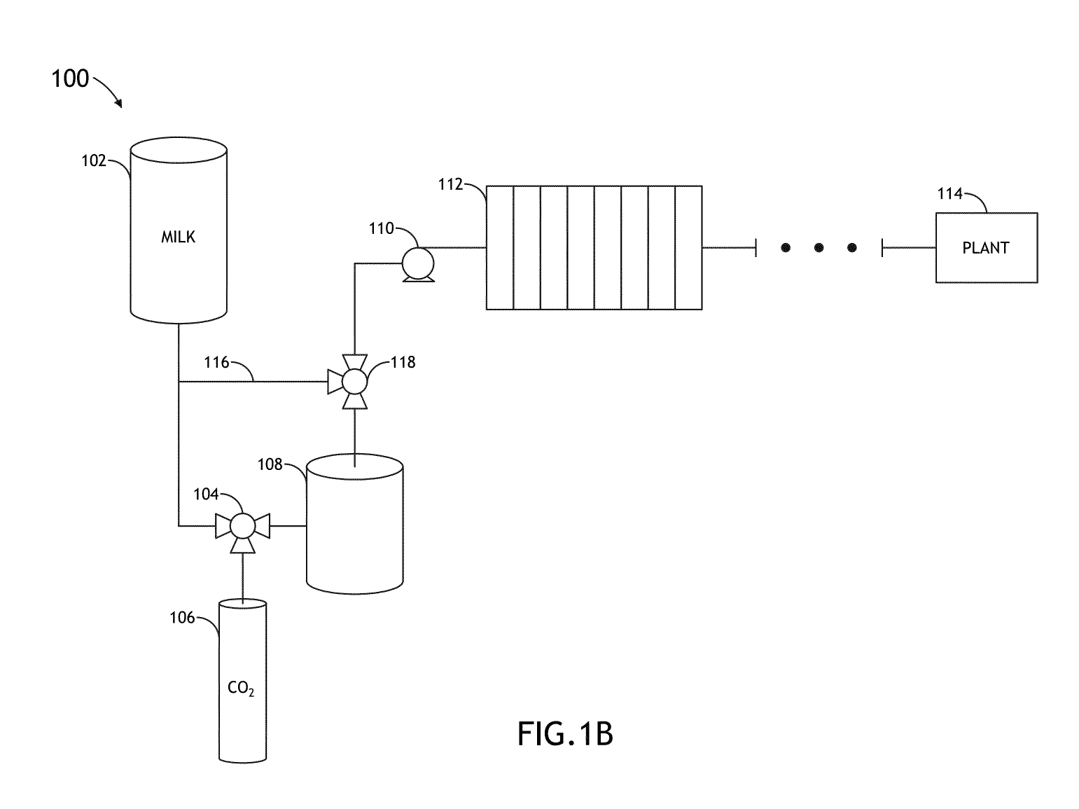

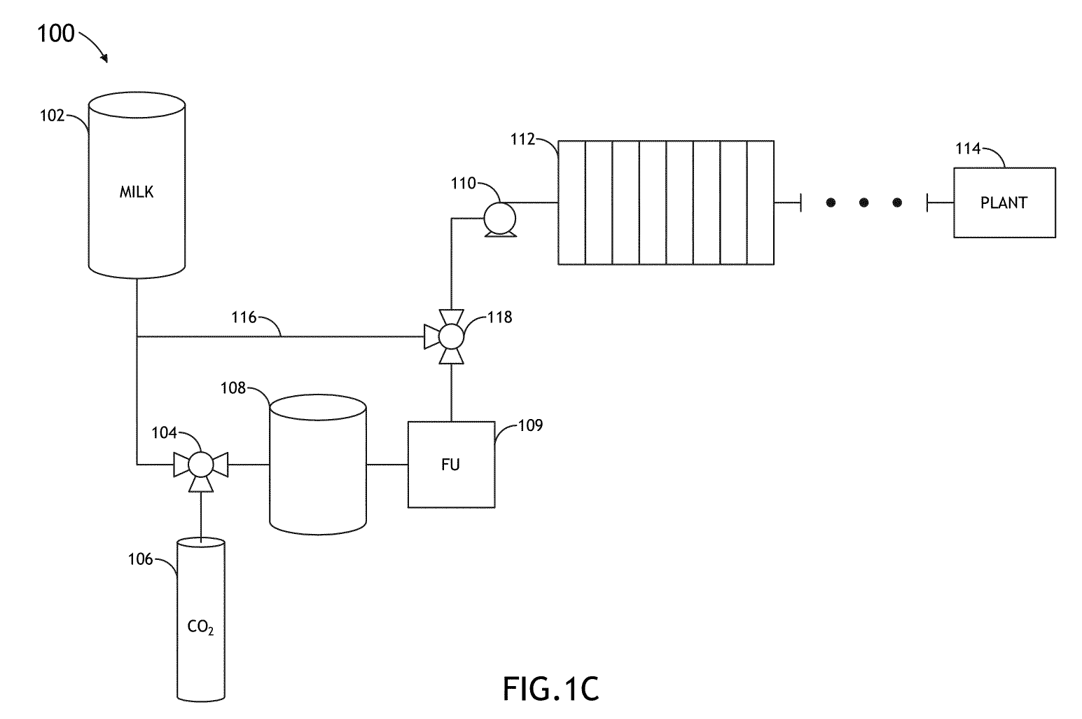

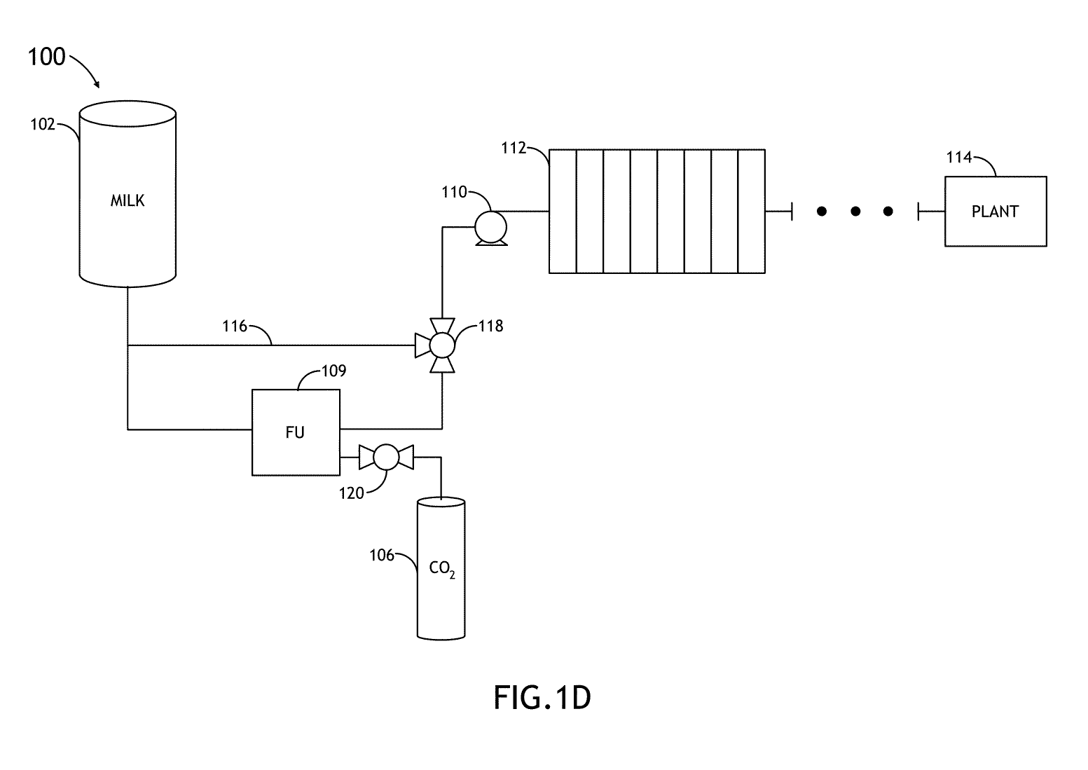

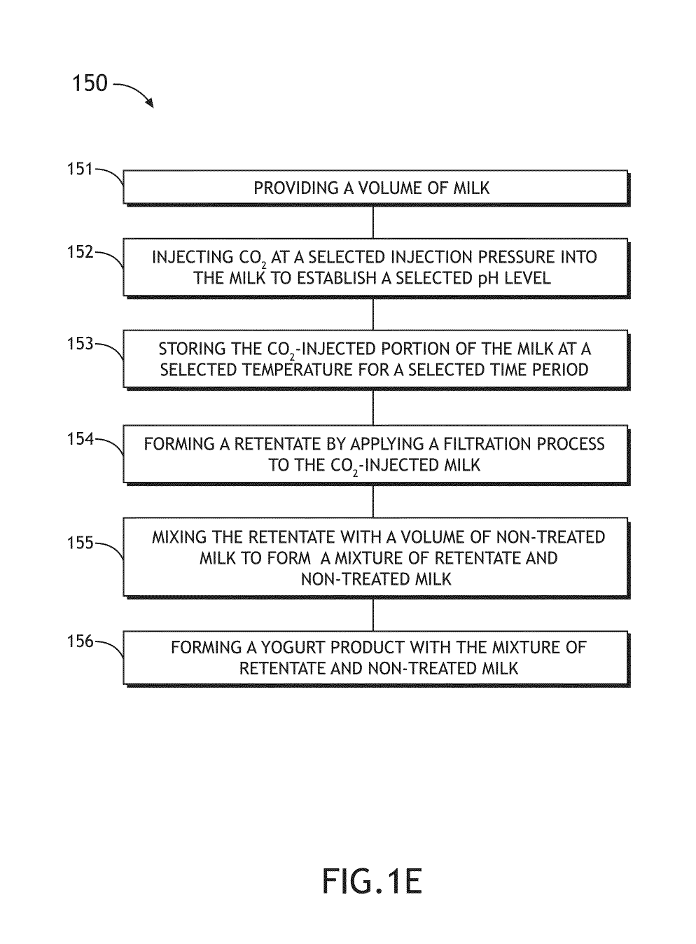

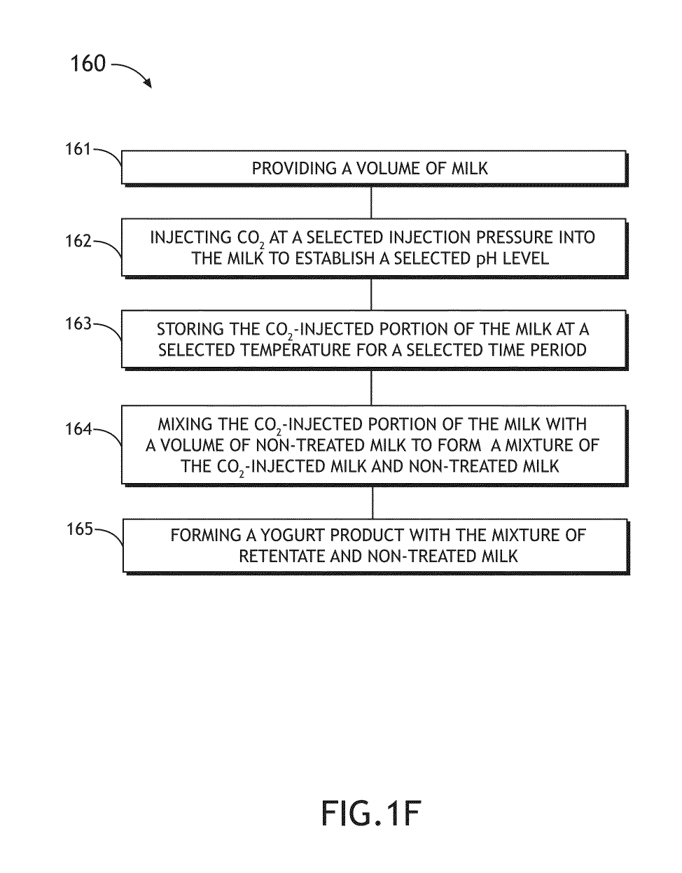

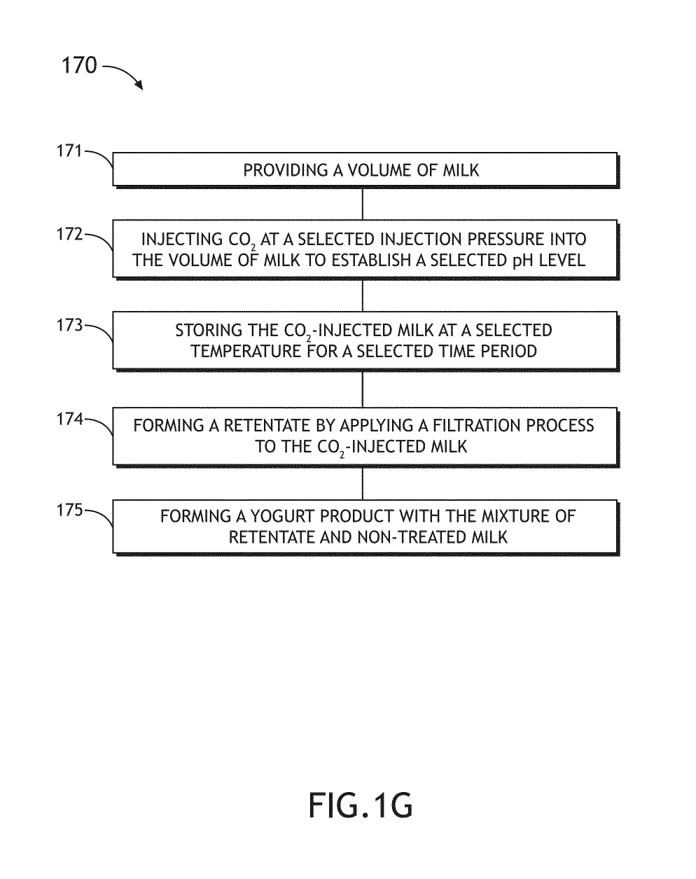

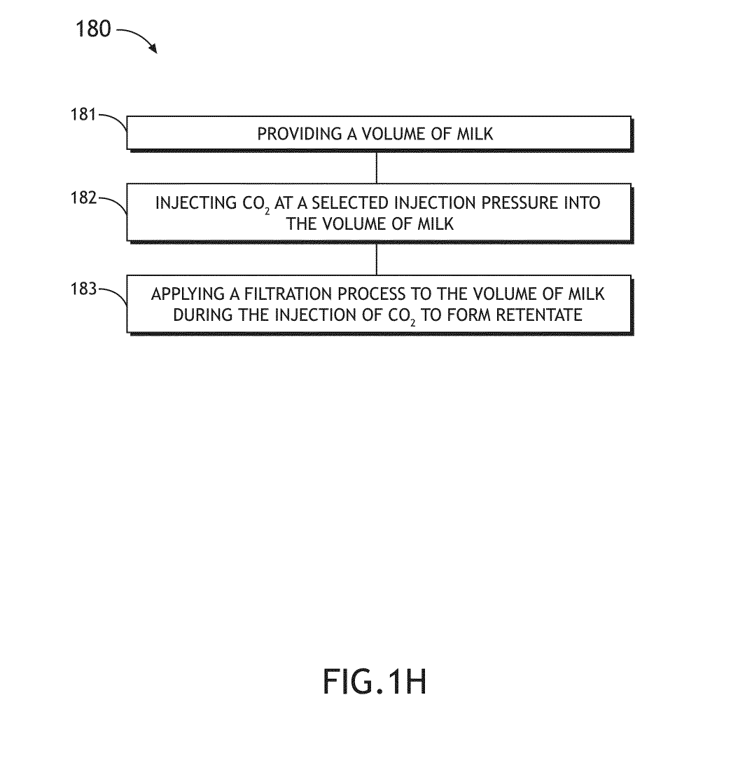

Referring generally to FIGS. 1A through 9, a system and method for improving texture in a yogurt product is described. The present disclosure generally relates to the preparation of set or stirred yogurt. Embodiments of the present disclosure are directed to the preparation of treated milk proteins, referred to herein as functional milk proteins (FMP), via carbon dioxide (CO₂) injection and filtration (e.g., membrane filtration), serving to make the proteins more functional. Additional embodiments of the present disclosure are directed to the partial replacement of total milk protein in yogurt milk with the prepared FMP (e.g., prepared via CO₂ treatment and/or filtration) in order to formulate the yogurt milk. Additional embodiments of the present disclosure are directed to the preparation of treated milk proteins via CO₂ injection, without the need for membrane filtration. Following the preparation of yogurt milk proteins, embodiments of the present disclosure may further apply a heating, cooling and/or an acidification process on the yogurt milk in order to form the given yogurt product. For instance, the acidification of the yogurt milk may be carried out using lactic acid bacteria or chemical acidification to reach the pH necessary for its gelation transforming the yogurt milk into yogurt.

Additional embodiments of the present disclosure are directed to forming a dried powder or other ingredient by drying the FMP formed by the filtration of the CO₂-injected milk. In addition, the dried powder may be used to partially replace the milk protein in the milk intended for yogurt manufacture.

Additional embodiments of the present disclosure are directed to the standardization of the protein composition of milk (e.g., skim milk or milk with fat content of 0.1 to 6.0%) for yogurt manufacture to the same protein content as the original milk by varying the ratio of casein protein to whey protein in the milk and then treating the standardized modified skim milk. For instance, the standardized modified skim milk may be treated utilizing the various processing steps described throughout the present disclosure. Additional embodiments of the present disclosure are directed to the standardization of yogurt milk to a selected protein content. For instance, such a standardization may be carried out with the adjustment of casein-to-whey protein ratios utilizing CO₂ treated milk proteins and a selected whey source. Additional embodiments of the present disclosure are directed to the replacement of natural untreated casein in the milk with carbon dioxide treated casein.

It is noted that embodiments of the present disclosure may provide for improved texture in a variety of yogurt products (e.g., yogurts). For example, embodiments of the present disclosure may produce improved texture in one or more of a stirred yogurt, a set yogurt, a Greek yogurt or any other type of yogurt known in the art of yogurt manufacture.

FIGS. 1A-1D illustrate various embodiments of a system 100 for making yogurt or a yogurt product. In one embodiment, as shown in FIG. 1A, the system 100 may include a milk source 102 (e.g., one or more milk tanks) for storing and providing a selected volume of skim milk or milk containing fat in the range 0.1 to 6.0%. For the purposes of the remainder of the present disclosure the milk source 102 is commonly referred to herein as a milk tank. It is noted, however, that the milk source 102 is not limited to one or more milk tanks as it is contemplated herein that alternative milk source devices may be implemented within the context of system 100.

For the purposes of the present disclosure the term “milk” should be interpreted to extend to “skim milk” and “milk containing fat in the range of 0.1 to 6.0%.” The milk tank 102 may maintain the volume of milk at or within a selected set of preparation parameters. For example, the milk tank 102 may maintain the milk at an initial pH in the range of pH 6.5-6.9. By way of another example, the milk tank 102 may maintain the milk at an initial protein content of 2.0-7.5% (w/w). By way of another example, the milk tank 102 may maintain the milk at a temperature between approximately 35-50° F. Further, the milk tank 102 may provide the prepared milk to a processing line of the system 100 via a first valve unit 104 for treatment. For example, the first valve unit 104 may include, but is not limited to, a three-way valve 104. By way of another example, the first valve unit 104 may include, but is not limited to, a set of two-way valves fluidically coupled via a T-junction (not shown). For the purposes of the present disclosure, the system 100 is generally described in the context of a three-way valve, as depicted in FIGS. 1A-1C. It is noted that this description is not a limitation and is provided merely for illustrative purposes as it is recognized herein that there exist a variety of ways in which milk from the milk source 102 is provided to the processing line of system 100.

In another embodiment, the system may 100 inject a selected amount of CO₂ into the provided volume of milk. The system 100 may include a CO₂ source 106 fluidically coupled to the process line of the system 100 via the first valve unit 104 (e.g., three-way valve), as shown in FIGS. 1A-1C. In this regard, the system 100 may inject CO₂ from the CO₂ source 106 into milk provided from the milk source 102 until a selected pH in the treated milk is attained. For example, the system 100 may inject CO₂ from a CO₂ source 106 into the milk stock by circulating CO₂ in a process line of system 100 having a selected back pressure (e.g., back pressure varying from 10-40 PSI). Further, the system 100 may inject CO₂ at a selected injection pressure and flow rate into the process line. For example, the system 100 may inject CO₂ via the process line at an injection pressure of 110 PSI and flow rate of 1.0 Liter/hour into the process line utilizing a sparger device. The system 100 may monitor the pH of the milk continuously throughout the injection process until the treated milk reaches the selected pH. For example, the injection process may be continued until a pH between approximately 5.7-6.2 is attained.

In another embodiment, the system 100 includes a storage unit 108. For example, the storage unit 108 includes, but is not limited to, one or more storage tanks. It is noted that for the purposes of the present disclosure the storage unit 108 is described as being a storage tank. It is further noted that this is not a limitation on system 100 as a variety of devices and/or systems may be used to store CO₂-injected milk.

In one embodiment, the storage unit 108 is suitable for storing the CO₂-injected portion of the milk at a selected temperature for a selected time period. For example, the storage unit 108 may include, but is not limited to one or more temperature controlled storage tanks. As shown in FIGS. 1A-1C, the storage unit 108 may also be fluidically coupled to the process line of the system 100 via the first valve unit 104 (e.g., three-way valve). In this regard, the storage unit 108 may receive CO₂-injected milk from the process line via the first valve unit 104. For example, the storage unit 108 may include a closed jacketed storage tank configured to store the CO₂-injected milk at a temperature between 35° and 50° F.

In another embodiment, as shown in FIG. 10, the system 100 includes a filtration unit (FU) 109 in fluidic communication with the storage tank 108. The filtration unit 109 may include any filtration unit or filtration technology known in the art for carrying out an ultra-filtration process, a micro-filtration process or a nano-filtration process in the context of dairy products. For example, the filtration unit 109 may include, but is not limited to, one or more membrane filters. For instance, the filtration unit 109 may include one or more membrane filters having a selected pore size for carrying out an ultra-filtration process. In another instance, the filtration unit 109 may include one or more membrane filters having a selected pore size for carrying out a micro-filtration process. In another instance, the filtration unit 109 may include one or more membrane filters having a selected pore size for carrying out a nano-filtration process. By way of example, the filtration unit 109 may form, or collect, a retentate by applying an ultra-filtration process, a micro-filtration process or a nano-filtration process to the CO₂-injected portion of the milk received from the storage unit 108. The retentate or concentrate formed by the filtration unit 109 is referred to herein as a functional milk protein (FMP) concentrate or treated milk proteins (T-MPC).

By way of example, the filtration unit 109 may filter the CO₂ treated milk received from the holding unit 108 through a 10 KDa membrane such that a protein concentration 5 times larger than the initial protein concentration of the milk is achieved. Further, the filtration process may be carried out simultaneously with the CO₂ injection process described previously herein. It is noted herein that the system 100 of the present disclosure is not limited to the 10 KDa membrane or the protein concentration described above, which are provided merely for illustrative purposes. It is recognized herein that the system of the present disclosure may be extended to any membrane type and any protein concentration suitable in the production of yogurt products.

In one embodiment, as shown in FIG. 1D, the system 100 may inject CO₂ gas into the milk during a filtration process. For example, the CO₂ source 106 may be fluidically coupled directly to the filtration unit 109. For instance, the CO₂ source 106 may be fluidically coupled to the filtration unit 109 via a third valve unit 120 (e.g., two-way valve).

In this regard, the system 100 may continuously or quasi-continuously (e.g., at regular intervals) inject CO₂ gas into the milk during the filtration process carried out by the filtration unit 109. In this sense, a retentate may be formed through the continuous (or quasi-continuous) injection of CO₂ into the milk during filtration by the filtration unit 109. It is noted herein that any of the various components and embodiments described with respect to FIGS. 1A-1C are applicable to FIG. 1D and vice-versa unless otherwise noted.

It is noted herein that, in some embodiments, system 100 need not include the filtration unit 109. In these instances, system 100 may supply milk from the storage unit 108 to downstream portions of the system 100, such as, but not limited to, the heat exchanger 112 or processing line 116 (for mixture with untreated milk), in a manner consistent with the embodiments described throughout the present disclosure.

In another embodiment, as shown in FIG. 1C, the system 100 may mix the retentate with a volume of non-treated milk to form a mixture of retentate and non-treated milk. For example, the output of the filtration unit (FU) 109 may be placed in fluidic communication with the milk tank 102 (or another tank) via a second valve unit 118. For example, the second valve unit 118 may include, but is not limited to, a three-way valve. By way of another example, the second valve unit 118 may include, but is not limited to, a set of two-way valves fluidically coupled via a T-junction (not shown). It is noted that the present description is not a limitation on system 100 and is provided merely for illustrative purposes as it is recognized herein that there exist a variety of ways in which milk from the milk source 102 is provided to the processing line of system 100.

In one embodiment, the processing line 116 is coupled to the output of the filtration unit 109 such that a retentate formed by filtration unit 109 may be mixed with non-treated milk from the milk tank 102 to form a milk mixture of retentate and non-treated milk. For example, the system 100 may mix the retentate and non-treated milk such that a selected portion of the milk protein in the non-treated milk is replaced with the treated milk protein. For instance, the system 100 may mix the retentate and non-treated milk such that 10-70% of the milk protein in the non-treated milk is replaced with the treated milk protein. In another embodiment, the total solids (TS) and the protein content of the mixed milk may be maintained in a manner consistent with the non-treated milk by adding water and/or lactose.

In one embodiment, the first valve unit 104, the second valve unit 118 and/or the third valve unit 120 are controlled manually. In another embodiment, the first valve unit 104, the second valve unit 118 and/or the third valve unit 120 are controlled automatically via a controller (not shown). In another embodiment, the controller includes one or more processors. In another embodiment, the controller includes one or more memory units (not shown). In another embodiment, the one or more memory units (e.g., memory) are configured to maintain program instructions. The program instructions, when executed by the one or more processors, are configured to open and/or close one or more of the pathways associated with the first valve unit 104, the second valve unit 118 and/or the third valve unit 120 in order to carry out one or more of the process steps of the present disclosure.

It is noted herein that in some embodiments system 100 need not mix the retentate from the filtration unit 109 and the non-treated milk from the milk tank 102. In these instances, system 100 may supply retentate from the filtration unit 109 to downstream portions of the system 100, such as, but not limited to, the heat exchanger, in a manner consistent with the embodiments described throughout the present disclosure.

In another embodiment, the system 100 may include one or more pumping units 110, as shown in FIGS. 1A-1D. The one or more pumping units 110 may be located at various locations within the fluid sub-system of system 100 and are generally configured to transfer the various liquid products throughout the system 100 as needed. For example, the one or more pumping units 110 may include one or more centrifugal pumps.

In another embodiment, the system 100 includes one or more heat exchangers 112 in fluidic communication with the output of the filtration unit 109. For example, in the case of retentate formation, the one or more heat exchangers 112 may receive the mixture of retentate and non-treated milk from the three-way valve 118. By way of another example, in the case where retentate is not formed, the one or more heat exchangers 112 may receive the mixture of the CO₂-injected milk and the non-treated milk from the three-way valve 118. The one or more heat exchangers 112 may be utilized to implement a heating and/or cooling process on the mixture of retentate and non-treated milk or the mixture of the CO₂-injected milk and the non-treated milk. In one embodiment, the one or more heat exchangers 112 may be used to heat treat the mixture at a selected temperature for a selected time. In one embodiment, the one or more heat exchangers 112 may be used to heat treat the mixture at a temperature in the range of 176-203° F. for a time period of 5 to 30 minutes. In another embodiment, the one or more heat exchangers 112 may be used to cool the mixture to a temperature suitable for incubation or cooled to a temperature below 50° F. for storage if milk is required to store. For example, the one or more heat exchangers 112 may be used to cool the mixture to a temperature in the range of 86-113° F. The mixture may then be stored in a tank at a temperature below 50° F. Alternatively, it is noted herein that the mixture may be first cooled to a selected temperature (e.g., 86-113° F.), stored and then later heated to a selected temperature (e.g., 176-203° F.) for heat treatment.

Although not shown, in other embodiments, where the mixture of non-treated milk and retentate are not required, the heat exchanger 112 may receive the retentate directly from the filtration unit 109. In other embodiments, as shown in FIG. 1B, where membrane filtration is not required, the heat exchanger 112 may receive a mixture of non-treated milk and CO₂-injected milk from a processing line 116 via three-way valve 118.

In another embodiment, the system 100 includes one or more heating units (not shown). The one or more heating units are configured to heat the CO₂-treated product so as to apply a heat treatment to the CO₂-treated product. By way of example, in the case of retentate formation, the heating unit may apply a heat treatment to the mixture of retentate and non-treated milk by heating the mixture to a selected temperature for a selected time. By way of another example, in the case without retentate formation, heating unit may apply a heat treatment to the mixture of the CO₂-injected milk and the non-treated milk by heating the mixture to a selected temperature for a selected time. The heating unit may include any one or more heating devices known in the art of dairy product manufacture. In one embodiment, the system 100 may include a dedicated heating tank equipped with one or more heaters suitable for heating the CO₂-treated product. In another embodiment, any one of the processing components of system 100 may be equipped with one or more heaters suitable for carrying out the heat treatment of the present disclosure.

In another embodiment, following heating and/or cooling treatment, the mixture of retentate and non-treated milk may be transferred to one or more portions of a yogurt manufacturing plant 114. In this regard, the outputted treated product from system 100 may be supplied to additional yogurt manufacturing facilities for further processing components known to those skilled in the art. In one embodiment, following heating and/or cooling treatment, the mixture of retentate and non-treated milk may further undergo acidification. For example, the mixture may undergo acidification via one or more bacterial cultures, such as, but not limited to, Streptococcus thermophilus and Lactobacillus delbrueckii subsp. bulgaricus. By way of another example, the mixture may undergo acidification via one or more chemical acidulates, such as, but not limited to, Glucono-delta-lactone or lactic acid.

In another embodiment, a powder or other ingredient is formed by drying the retentate formed from the filtration of the CO₂-injected milk. In this regard, the powder may be used to partially replace the milk protein in milk intended for yogurt manufacture. For example, the powder may be mixed with non-treated milk from milk tank 102 in order to replace 10-70% of the milk proteins in the yogurt milk or yogurt formulations. In addition, water and/or lactose may be added to the formulations to obtain the desired final protein percentage and total solids. It is further noted that the mixture of non-treated milk and the powder may undergo heat and/or cooling treatment and further processing as described previously herein.

In another embodiment, the powder-form of the retentate need not immediately undergo further processing. In this regard, the dried powder may be stored and later used in any manufacture process known in the art, including, but not limited to, the manufacture of yogurt, as described throughout the present disclosure.

In another embodiment, the protein composition of the treated milk may be standardized to the same protein content as the original milk prior to treatment. For example, the protein composition of the milk may be standardized to the same protein content as the original milk by varying the ratio of casein protein to whey protein in the milk from 1:1 to 9:1 (standardized modified milk) and then treating the standardized modified milk utilizing the various processing steps described throughout the present disclosure.

FIG. 1E illustrates a process flow 150 depicting a method for improving the texture of yogurt or a yogurt product, in accordance with one or more embodiments of the present disclosure. It is noted herein that the system 100 may carry out the various process steps of flow diagram 150. It is further noted herein, however, that the process depicted in flow diagram 150 is not limited to the architecture of system 100 and it is recognized that additional analogous system-level architectures may be constructed to carry out all or a portion of the steps in process flow 150.

In a first step 151, a volume of milk is provided. In one embodiment, the volume of milk is provided so as to have an initial selected pH, a selected protein content and a selected temperature. For example, the provided milk may have an initial pH in the range of 6.3-7.0. By way of another example, the provided milk may have a protein content between 2.0-7.5% (w/w). By way of another example, the provided milk may be maintained at a temperature of 35-50°. For instance, the milk tank 102 may maintain a volume of milk at an initial pH in the range 6.3-7.0, a protein content between 2.0-7.5% (w/w), and a temperature between 35-50° and provide the milk to a processing line of the system via the three-way valve 104.

In a second step 152, a selected amount of CO₂ is injected into the provided volume of milk. In this regard, a selected amount of CO₂ may be injected into milk provided from the milk tank 102 in order to establish a selected pH in the milk. For example, the system 100 may inject CO₂ into the milk stock by circulating CO₂ in a process line of system 100 having a selected back pressure varying from 10-40 PSI. The system 100 may inject CO₂ at a selected pressure (e.g., 110 PSI) and flow rate (e.g., 1.0 Liter/hour) into the process line (with help of Sparger).

In a third step 153, the CO₂-injected milk is stored at a selected temperature for a selected time period. For example, the CO₂-injected milk is stored in the storage tank 108 at a selected temperature for a selected time period. For example, the storage tank 108 may include a closed jacketed storage tank configured to store the CO₂-injected milk at a temperature between 35° and 50° F.

In a fourth step 154, a retentate (or concentrate) is formed by applying a filtration process to the CO₂-injected portion of the milk. In one embodiment, the filtration unit 109 may be used form, or collect, a retentate (or concentrate). For example, the filtration unit 109 may include, but is not limited to, a membrane filter. For instance, the filtration unit 109 may filter the CO₂ treated milk received from the holding unit 108 through a 10 KDa membrane such that a protein concentration 5 times larger than the initial protein concentration of the milk is achieved. The retentate formed via the retentation/concentration formation step 156 includes a functional milk protein (FMP) concentrate or a treated milk protein concentrate (T-MPC)

In a fifth step 155, the retentate is mixed with a volume of non-treated milk to form a mixture of retentate and non-treated milk. For example, the system 100 may mix the retentate (e.g.., the FMP) and non-treated milk such that a selected portion of the milk protein in the non-treated milk is replaced with the treated milk protein. For instance, the system 100 may mix the retentate and non-treated milk such that 10-70% of the milk protein in the non-treated milk is replaced with the treated milk protein.

In a sixth step 156, a yogurt product is formed using the mixture of retentate and non-treated milk. For example, set yogurt, stirred yogurt or Greek yogurt may be formed using the mixture of retentate and non-treated milk. In one embodiment, the mixture of retentate and non-treated milk is heat treated. For example, the one or more heat exchangers 112 may be used to heat treat the mixture at a temperature in the range of 176-203° F. for a time period of 5 to 30 minutes. In another embodiment, the heated mixture of retentate and non-treated milk is cooled to a temperature suitable for incubation or is cooled to a temperature below 50° F. for storage. For example, the one or more heat exchangers 112 may be used to cool the mixture to a temperature in the range of 86-113° F.

In a further step, the cooled mixture of retentate and non-treated milk may undergo acidification. For example, the mixture may undergo acidification via one or more bacterial cultures, such as, but not limited to, Streptococcus thermophilus and Lactobacillus delbreuckii subsp. bulgaricus. By way of another example, the mixture may undergo acidification via one or more chemical acidulates, such as, but not limited to, Glucono-delta-lactone.

FIG. 1F illustrates a process flow 160 depicting a method for improving the texture of yogurt or a yogurt product, in accordance with one or more embodiments of the present disclosure. It is noted that the process flow 160 may form a yogurt product without forming retentate (as in process flow 150). It is noted herein that the system 100 may carry out the various process steps of flow diagram 160. It is further noted herein, however, that the process depicted in flow diagram 160 is not limited to the architecture of system 100 and it is recognized that additional analogous system-level architectures may be constructed to carry out all or a portion of the steps in process flow 160.

It is further noted that the embodiments and examples of process flow 150 should be interpreted to extend to process flow 160, unless otherwise noted.

In a first step 161, a volume of milk is provided. In one embodiment, the volume of milk is provided so as to have an initial selected pH, a selected protein content and a selected temperature.

In a second step 162, a selected amount of CO₂ is injected into the provided volume of milk. For example, a selected amount of CO₂ may be injected into milk provided from the milk tank 102 in order to establish a selected pH in the milk.

In a third step 163, the CO₂-injected milk is stored at a selected temperature for a selected time period. For example, the CO₂-injected milk is stored in the storage tank 108 at a selected temperature for a selected time period.

In a fourth step 164, the CO₂-injected milk is mixed with a volume of non-treated milk to form a mixture of CO₂-injected milk and non-treated milk. For example, the system 100 may mix the CO₂-injected milk and non-treated milk such that a selected portion of the milk protein in the non-treated milk is replaced with the treated milk protein.

In a fifth step 165, a yogurt product is formed using the mixture of retentate and non-treated milk. For example, set yogurt, stirred yogurt or Greek yogurt may be formed using the mixture of retentate and non-treated milk. As previously noted, the mixture of CO₂-injected milk and non-treated milk may undergo heat treatment, cooling and/or acidification in order to form a selected yogurt product.

FIG. 1G illustrates a process flow 170 depicting a method for improving the texture of yogurt or a yogurt product, in accordance with one or more embodiments of the present disclosure. It is noted that the process flow 170 forms a yogurt product without mixing retentate (or CO₂-injected milk) with non-treated milk. It is noted herein that the system 100 may carry out the various process steps of flow diagram 170. It is further noted herein, however, that the process depicted in flow diagram 170 is not limited to the architecture of system 100 and it is recognized that additional analogous system-level architectures may be constructed to carry out all or a portion of the steps in process flow 170.

It is further noted that the embodiments and examples of process flows 150 and 160 should be interpreted to extend to process flow 170, unless otherwise noted.

In a first step 171, a volume of milk is provided. In one embodiment, the volume of milk is provided so as to have an initial selected pH, a selected protein content and a selected temperature.

In a second step 172, a selected amount of CO₂ is injected into the provided volume of milk. For example, a selected amount of CO₂ may be injected into milk provided from the milk tank 102 in order to establish a selected pH in the milk.

In a third step 173, the CO₂-injected milk is stored at a selected temperature for a selected time period. For example, the CO₂-injected milk is stored in the storage tank 108 at a selected temperature for a selected time period.

In a fourth step 174, a retentate (or concentrate) is formed by applying a filtration process to the CO₂-injected portion of the milk. In one embodiment, the filtration unit 109 may be used to form, or collect, a retentate (or concentrate).

In a fifth step 175, a yogurt product is formed using the retentate formed in step 174. For example, set yogurt, stirred yogurt or Greek yogurt may be formed using the retentate formed in step 174. As previously noted, the retentate may undergo heat treatment, cooling and/or acidification in order to form a selected yogurt product.

FIG. 1H illustrates a process flow 180 depicting a method for improving the texture of yogurt or a yogurt product, in accordance with one or more embodiments of the present disclosure. It is noted herein that the system 100 may carry out the various process steps of flow diagram 180. It is further noted herein, however, that the process depicted in flow diagram 180 is not limited to the architecture of system 100 and it is recognized that additional analogous system-level architectures may be constructed to carry out all or a portion of the steps in process flow 180.

It is further noted that the embodiments and examples of process flow 150, 160 and 170 should be interpreted to extend to process flow 180, unless otherwise noted.

In a first step 181, a volume of milk is provided. In one embodiment, the volume of milk is provided so as to have an initial selected pH, a selected protein content and a selected temperature.

In a second step 182, CO₂ is injected into the provided volume of milk. In a third step 183, a filtration process is applied to the volume of milk during the injection of CO₂ to form retentate. In one embodiment, a selected amount of CO₂ may be injected into milk provided from the milk tank 102 in order to establish a selected pH in the milk. In another embodiment, CO₂ is continuously injected into the volume of milk. In another embodiment, CO₂ is periodically injected into the volume of milk of continuously. For example, the valve unit 120 may periodically open/close to establish a periodic (or non-periodic) delivery of CO₂, in select periodic delivery volumes, to the milk as the milk is undergoing filtration in the filtration unit 109. It is noted herein that such a periodic delivery of CO₂ to the filtration unit 109 may be regulated by a controller (not shown) configured to transmit control signals to an electronically controllable valve unit 120. The continuous or periodic injection of CO2 into the milk during filtration serves to form a retentate.

In a further step, the retentate is mixed with a volume of non-treated milk to form a mixture of retentate and non-treated milk. For example, the system 100 may mix the retentate and non-treated milk such that a selected portion of the milk protein in the non-treated milk is replaced with the treated milk protein.

In a further step, a yogurt product is formed using the mixture of retentate and non-treated milk. For example, set yogurt, stirred yogurt or Greek yogurt may be formed using the mixture of retentate and non-treated milk. As previously noted, the mixture retentate and non-treated milk may undergo heat treatment, cooling and/or acidification in order to form a selected yogurt product.

It is understood that the specific order or hierarchy of steps in the methods 150, 160, 170 and 180 are provided for illustrative purposes. Based upon design preferences, it is understood that the specific order or hierarchy of steps in the methods can be rearranged while remaining within the scope of the disclosed subject matter. Moreover, it is further contemplated herein that one or more of the steps of the methods 150, 160 170 and 180 may be removed while remaining within the scope of the disclosed subject matter. In this sense, each of the steps depicted in the methods 150, 160 170 and 180 should be interpreted as optional.

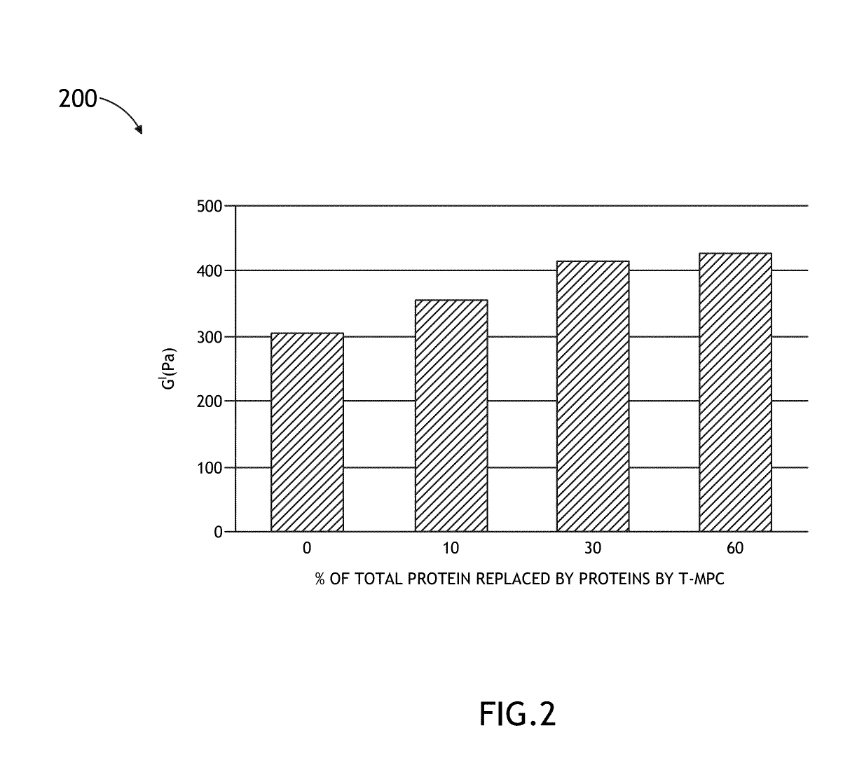

FIG. 2 illustrates the effect of replacing protein in milk with the treated milk protein of the present invention on the elastic moduli G′ of the product yogurt of the present invention. Those skilled in the art will recognize that a measurement of G′ is indicative of the firmness, viscosity, body and firmness of a tested yogurt product. As shown in FIG. 2, significant improvements in firmness, viscosity, body and texture are realized with increased levels of replacement of milk protein with the functional milk proteins of the present invention. As such, yogurt produced using the treatment process of the present disclosure has better body and texture when compared to yogurt manufactured with non-treated milk. It is noted herein that the ingredients treated with carbon dioxide are more functional than non-treated ingredients and aid in reducing expensive stabilizers and hydrocolloids. In addition, carbon dioxide treatment is inexpensive and generally considered a ‘natural process.’ Therefore, the embodiments of the present invention may provide clean label products at low cost, without compromising taste and texture.

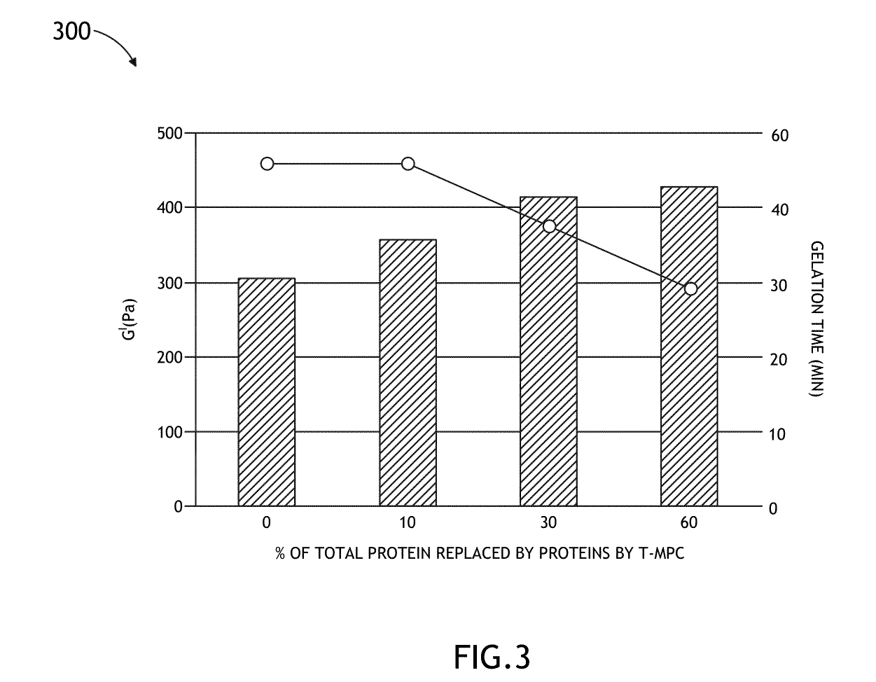

FIG. 3 illustrates the effect of replacing protein in milk with the treated milk protein of the present invention on the gelation time of the yogurt milk. As shown in FIG. 3, the gelation time of the yogurt milk decreases with increased levels of replacement of milk protein with the functional milk protein concentrates of the present invention. As such, throughput and/or efficiency of a yogurt manufacturing process implementing the treatment process(es) of the present may be significantly improved.

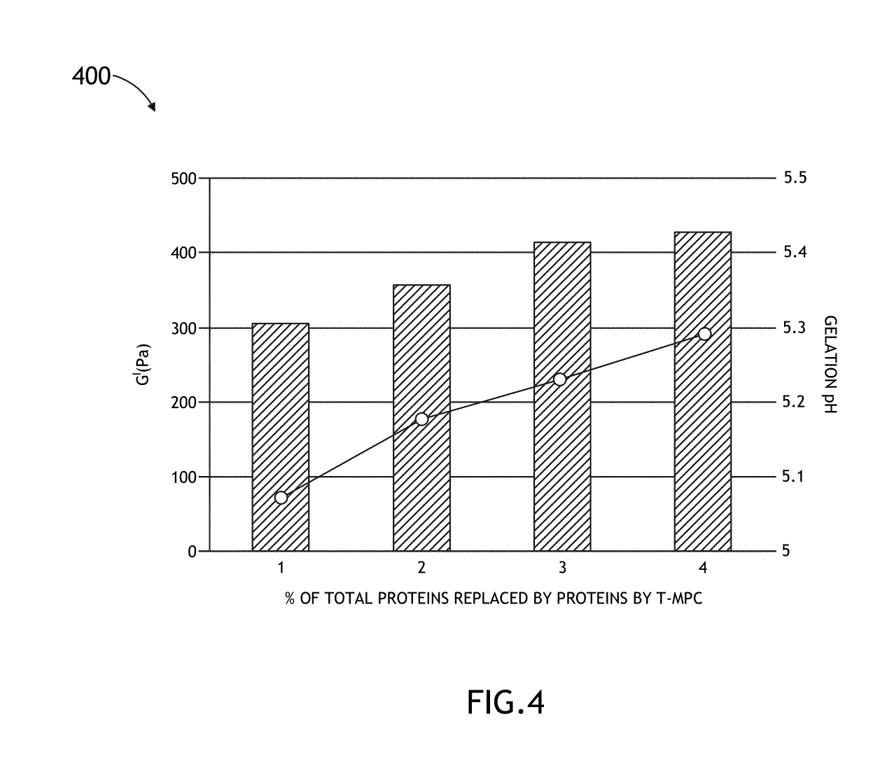

FIG. 4 illustrates the effect of replacing protein in milk with the treated milk protein of the present invention on the gelation pH of the yogurt milk. As shown in FIG. 4, the gelation pH of the yogurt milk increases with increased levels of replacement of milk protein with the functional milk protein concentrates of the present invention. As such, it is anticipated that yogurt produced using the treatment process(es) of the present invention will provide a yogurt with less acidic taste, while also having a longer shelf life and displaying a lower level of synercsis.

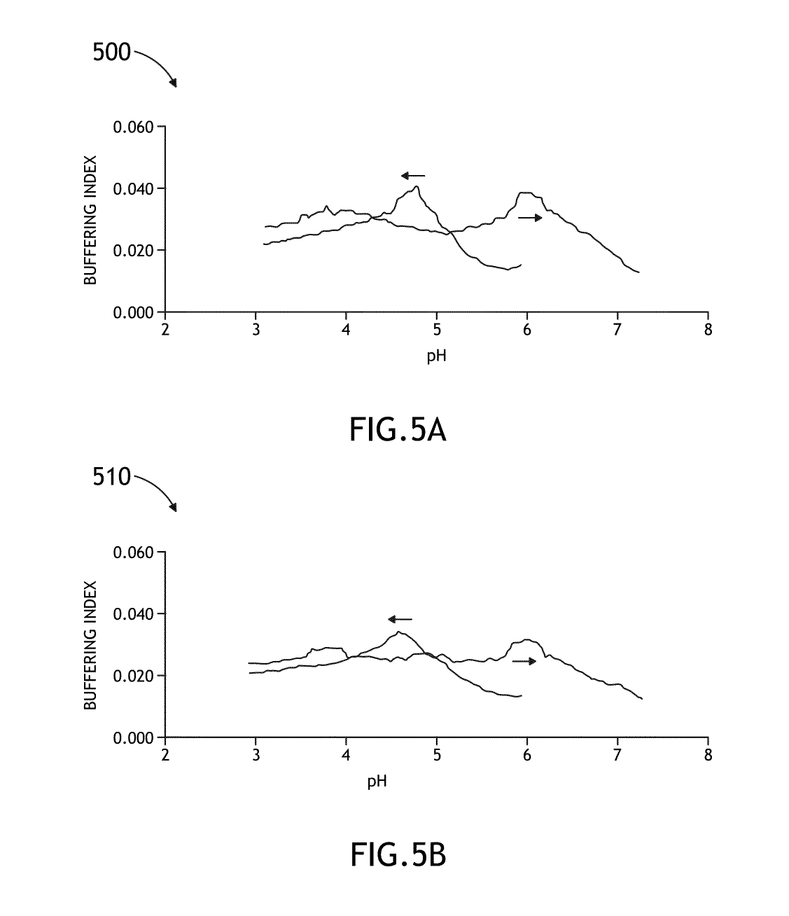

FIGS. 5A and 5B illustrate the dependence of buffering index on pH, which is modified by the CO₂ treatment of milk of the present disclosure. In this regard, the injection of CO₂ into milk and the subsequent replacement of a portion of non-treated milk with the treated retentate/concentrate of the present disclosure may serve to control the buffering capacity of the yogurt milk. As such, the fermentation time required for yogurt manufacture may be reduced as a result of the CO₂ treatment and subsequent membrane filtration of the present disclosure.

While the foregoing disclosure has focused on the CO₂ treatment and the formation of a functional milk protein concentration via membrane filtration, it is further contemplated herein that a variety of formulations may be utilized to prepare set or stirred yogurt. As noted previously herein, yogurt milk used in the preparation of set or stirred yogurt may have, but is not limited to, a protein content between 2.0 and 7.5% (w/w).

For example, in the case of stirred yogurts formed with skim milk having a protein content of 3.1% (w/w), results are listed In Table I.

TABLE I

| | Consistency | Flow | Apparent |
|---|---|---|---|
| | coefficient | index | viscosity |
| Sample | (K) | (n) | (η) |
| Skim milk | 4.11 | 0.32 | 0.23 |
| Skim milk with | 10.95 | 0.24 | 0.44 |
| starch and | | | |
| gelatin | | | |
| Skim milk with | 8.61 | 0.16 | 0.24 |
| CO₂ proteins | | | |
| Skim milk with | 3.75 | 0.32 | 0.21 |
| CO₂ proteins | | | |
| and 65:35 | | | |
| casein/whey | | | |

As shown in Table I, skim milk yogurt formed with milk having 3.1% (w/w) protein content displayed a consistency coefficient K (measured in Pa·Sⁿ) of 4.11, where yogurt formed with skim milk treated with starch and gelatin displayed a consistency coefficient of 10.95. Further, yogurt formed with skim milk mixed with CO₂ proteins, as described throughout the present disclosure, displayed a consistency coefficient of 8.61. In addition, yogurt formed with skim milk mixed with CO₂ proteins and having a 65:35 casein-to-whey protein ratio, as described throughout the present disclosure, displayed a consistency coefficient of 3.75.

In addition, skim milk yogurt formed with milk having a 3.1% (w/w) protein content displays a flow index n of 0.32, where yogurt formed with skim milk treated with starch and gelatin display a flow index of 0.24. Yogurt formed with skim milk mixed with CO₂ proteins displayed a flow index of 0.16. In addition, yogurt formed with skim milk mixed with CO₂ proteins and having a 65:35 casein-to-whey protein ratio, as described throughout the present disclosure, displayed a flow index of 0.32.

Further, at a shear rate of 70 S⁻¹, skim milk yogurt formed with milk having 3.1% (w/w) protein content displayed an apparent viscosity (measured in Pa·S) of 0.23, where yogurt formed with skim milk treated with starch and gelatin displayed an apparent viscosity of 0.44. Further, yogurt formed with skim milk mixed with CO₂ proteins, as described throughout the present disclosure, displayed an apparent viscosity of 0.24. Yogurt formed with skim milk mixed with CO₂ proteins and having a 65:35 casein-to-whey protein ratio displayed an apparent viscosity of 0.21.

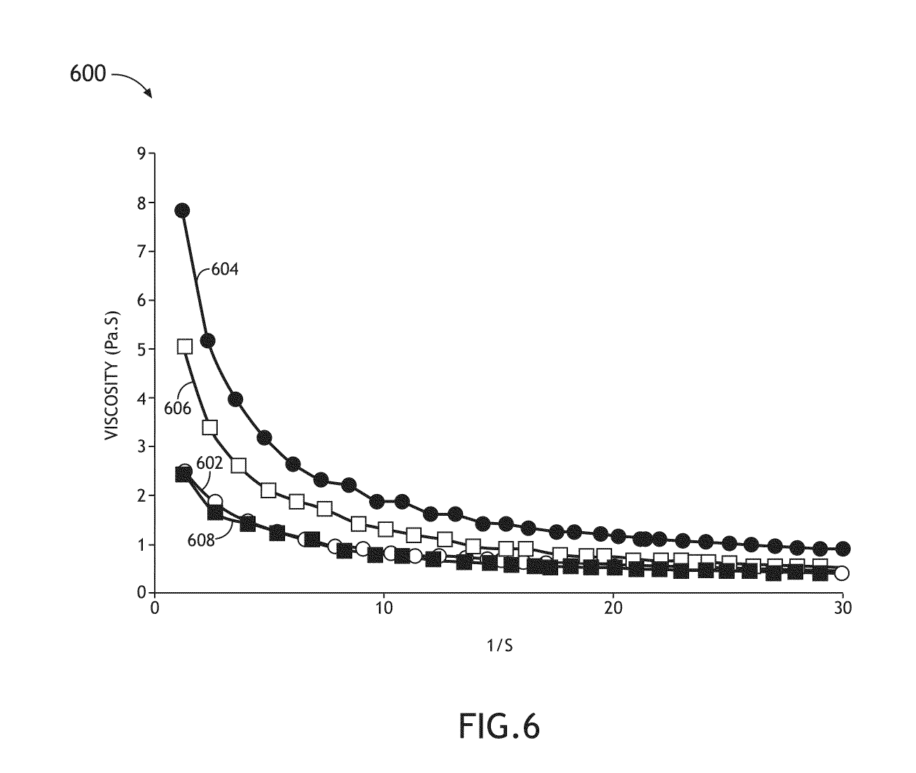

FIG. 6 illustrates a series of apparent viscosity profiles for the yogurt samples listed above as a function of shear rate. The apparent viscosity is displayed in units of Pa·S, where shear rate is displayed in reciprocal seconds (1/S). Curve 602 depicts the apparent viscosity of skim milk yogurt formed with milk having a 3.1% (w/w) protein content as a function of shear rate. Curve 604 depicts the apparent viscosity of yogurt formed with skim milk treated with starch and gelatin. Curve 606 depicts the apparent viscosity of yogurt formed with skim milk mixed with CO₂ proteins, such that 50% of the skim milk protein is substituted with CO₂-treated proteins, as a function of shear rate. Curve 608 depicts the apparent viscosity of yogurt with 50% CO₂ treated protein substitution and a 65:35 casein-to-whey protein ration, as a function of shear rate.

It is noted that the yogurt product of the present disclosure is not limited to the protein content, the level of CO₂-treated protein substitution or the casein-to-whey ratio provided above. These values are provided merely for illustrative purposes.

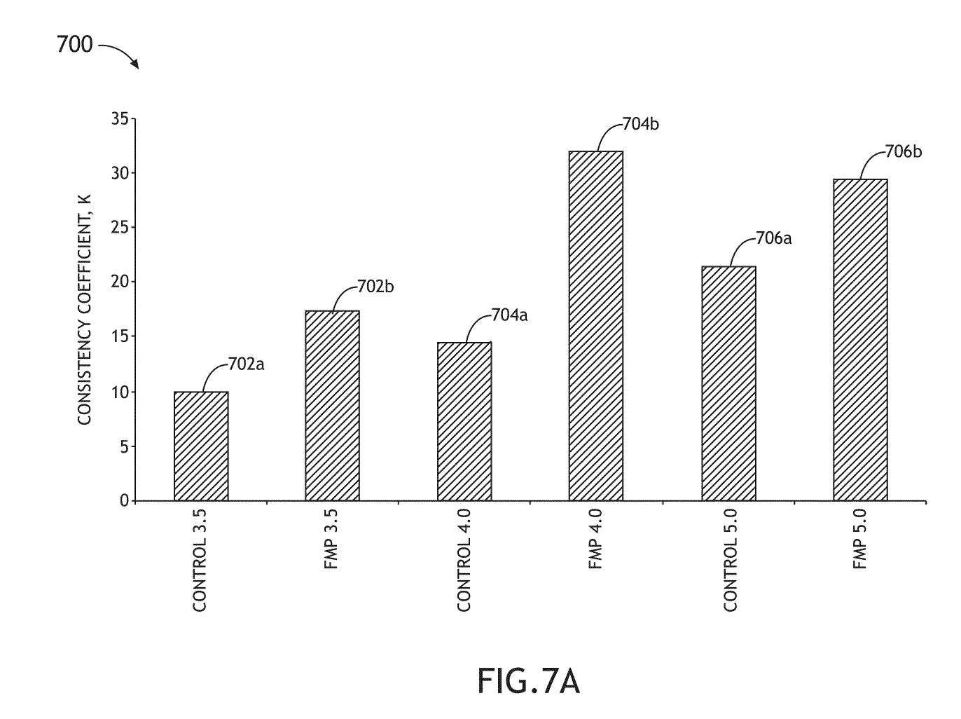

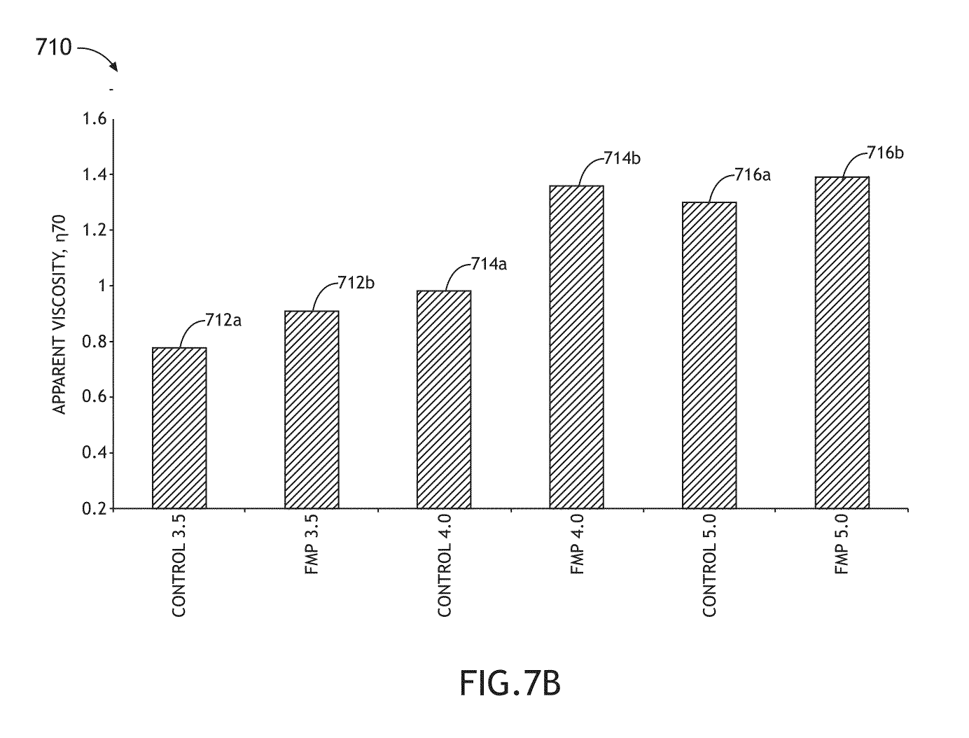

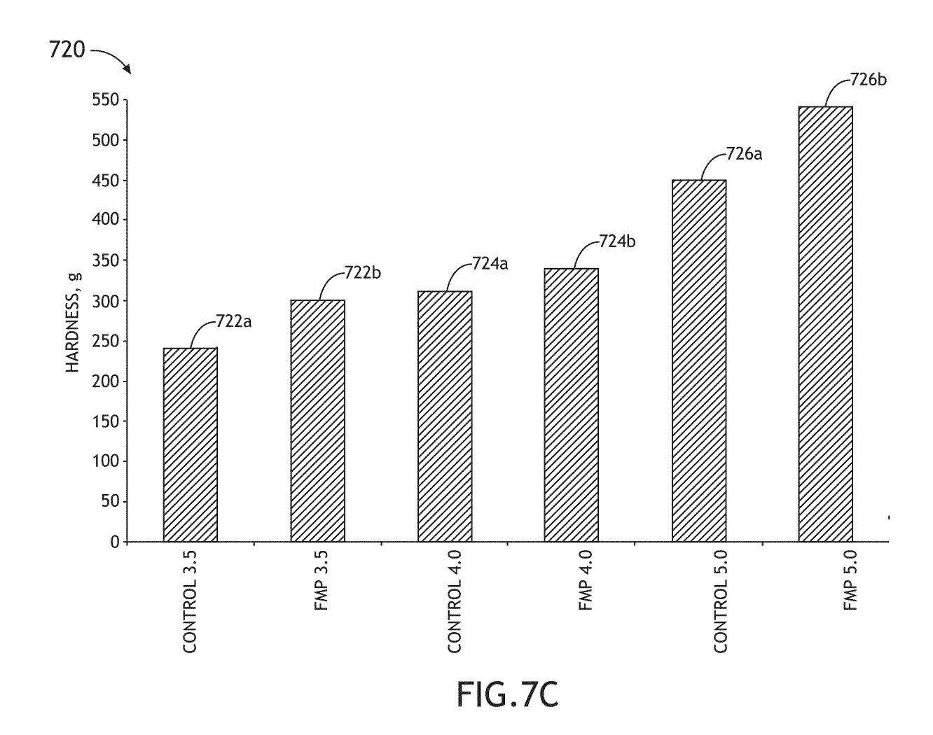

FIGS. 7A-7C illustrate a series of data measured from a variety of control samples and FMP-substituted samples, in accordance with one or more embodiments of the present disclosure. In the case of set yogurts, the consistency coefficient, the flow index and apparent viscosity have been measured for a series of protein content values for both a control yogurt and a yogurt formed with FMP substitution.

FIG. 7A illustrates the consistency coefficient measured for a series of control and FMP-substituted samples of set yogurt. As shown in FIG. 7A, the consistency coefficient was measured for both a control sample and an FMP-substituted sample at a protein content of 3.5%, 4.0% and 5.0% (w/w). It is noted herein that the FMP-substituted samples contained 50% FMP substitution.

It is further noted that, at each value of protein content, the FMP-substituted sample displayed an improved value of the consistency coefficient K. For example, as show in FIG. 7A, each of the measurements 702b, 704b, and 706b, corresponding with the FMP-substituted samples, displayed an increased consistency coefficient relative to the respective control measurements 702a, 704a and 706a. These results indicate the improved consistency of the resulting yogurt product achieved by the FMP-substitution of the present disclosure.

FIG. 7B illustrates the apparent viscosity measured at 70 S⁻¹ for a series of control and FMP-substituted samples of set yogurt. As shown in FIG. 7B, the apparent viscosity was measured again for both a control sample and the FMP-substituted sample at a protein content of 3.5%, 4.0% and 5.0% (w/w). It is again noted that the FMP-substituted samples contained 50% FMP substitution.

It is further noted that, at each value of protein content, the FMP-substituted sample displayed an improved value of the apparent viscosity. For example, as show in FIG. 7B, each of the measurements 712b, 714b, and 716b, corresponding with the FMP-substituted samples, displayed an increased apparent viscosity (measured at 70 S⁻¹) relative to the respective control measurements 712a, 714a and 716a. These results indicate a consistent improvement in yogurt viscosity for FMP-substituted yogurt.

FIG. 7C illustrates the hardness g measured for a series of control and FMP-substituted samples of set yogurt. As shown in FIG. 7C, the hardness was measured again for both a control sample and the FMP-substituted sample at a protein content of 3.5%, 4.0% and 5.0% (w/w). It is again noted that the FMP-substituted samples contained 50% FMP substitution.

It is further noted that, at each value of protein content, the FMP-substituted sample displayed an improved value of hardness. For example, as show in FIG. 7C, each of the measurements 722b, 724b, and 726b, corresponding with the FMP-substituted samples, displayed an increased hardness relative to the respective control measurements 722a, 724a and 726a. These results indicate a consistent improvement in yogurt hardness for FMP-substituted yogurt.

The results associated with FIGS. 7A-7C are summarized In Table II. It is noted that the apparent viscosity values listed in Table II correspond to the apparent viscosity measured at 70 S⁻¹.

TABLE II

| | Consistency | Flow | Apparent |
|---|---|---|---|
| | coefficient | index | viscosity |
| Sample | (K) | (n) | (η) |
| 3.5% protein | 9.97 | 0.35 | 0.58 |
| Control | | | |
| 3.5% protein | 17.36 | 0.25 | 0.71 |
| FMP at 50% | | | |
| 4.0% protein | 14.5 | 0.33 | 0.78 |
| Control | | | |
| 4.0% protein | 32.0 | 0.23 | 1.16 |
| FMP at 50% | | | |
| 5.0% protein | 21.44 | 0.32 | 1.10 |
| Control | | | |
| 5.0% protein | 29.48 | 0.26 | 1.19 |
| FMP at 50% | | | |

The results listed in Table II indicate a consistent improvement in yogurt consistency, viscosity and hardness for FMP-substituted yogurt samples across a range of protein content values. It is noted that the yogurt product of the present disclosure is not limited to the protein content, the level of CO₂-treated protein substitution or the casein-to-whey ratio provided above. These values are provided merely for illustrative purposes.

While the foregoing disclosure has focused on the CO₂ treatment and the formation of a FMP concentration via filtration, it is further contemplated herein that the following formulations may be used for preparation of Greek-style yogurt. It is further recognized herein that the following embodiments may provide a significant improvement in yogurt texture and aid in the elimination of the acid whey problems, which are commonly faced in the manufacture of Greek-style yogurt.

In one embodiment, a yogurt is manufactured using yogurt milk standardized to a selected protein content. For example, the yogurt may be, but is not required to be, manufactured using yogurt milk standardized to a selected protein content of 2.0 to 7.5%. In addition, casein-to-whey protein ratios may be adjusted from 80:20 (casein-to-whey) to 20:80 or various combinations in between (e.g. 70:30, 65:35, 60:40, 55:45, 50:50, 45:55, 40:60 and the like). The adjustment of the casein-to-whey protein ratio may be carried out utilizing CO₂ treated milk proteins, such as those described previously herein, as a source of casein. Further, sources of whey protein may include, but are not limited to, a whey powder, demineralized whey protein, whey protein concentrate or whey protein isolate.

In another embodiment, the water, protein, lactose and/or the total solids may be adjusted in a manner similar to that described previously herein.

In another embodiment, the pH of the yogurt milk may be varied in a range between pH 6.3 to 7.0. In another embodiment, the yogurt milk may be preheated at temperatures between 176-203° F. for times ranging from 5-30 minutes. In another embodiment, following the heat treatment, the yogurt milk may be cooled to incubation temperatures between 86-113° F. Further, following cooling, the yogurt milk may undergo an acidification process utilizing bacterial cultures or a chemical acidulant, as described previously herein.

In another embodiment, the resulting yogurt may be subject to small amplitude oscillatory rheology (SAOR) measurements in order to yield data on elastic modulus (or G′), viscosity, pH at gelation and time of gelation.

It is noted herein that the reactivity of casein in the carbon dioxide treated milk is much higher compared to that of non-treated milk. It is recognized herein that by increasing the whey protein content in the yogurt milk the yogurt produced by such treated milk may display higher viscosity, gel strength, higher pH of gelation and a reduction in manufacture time. It is further anticipated that the adjustment of the pH of the yogurt milk, as standardized above, prior to heat treatment, will also give the product yogurt better texture.

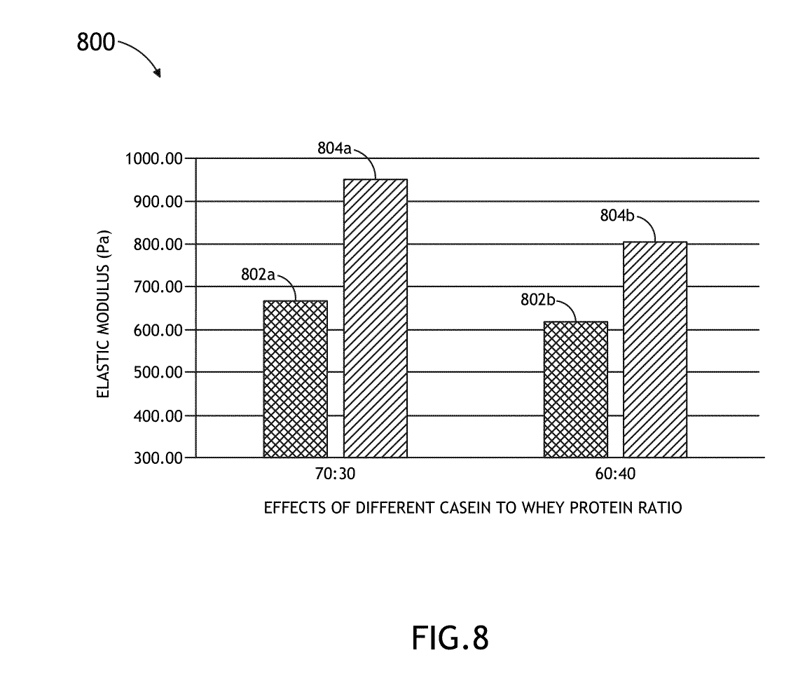

FIG. 8 illustrates a comparison between the elastic modulus of Greek-style yogurt manufactured with yogurt milk standardized to 7.5% protein content and adjusted to different casein-whey protein ratios using standard milk protein concentrate and CO₂ treated milk protein concentrate and whey protein concentrates. As shown in FIG. 8, the elastic modulus associated with Greek yogurt produced by the yogurt milk formulations standardized using untreated/standard milk protein concentrates and whey protein mixture are represented by columns 802a and 802b. In addition, the elastic modulus associated with Greek yogurt produced by the yogurt milk formulations standardized using carbon dioxide treated milk protein concentrates and whey protein mixture are represented by columns 804a and 804b. As shown in FIG. 8, the elastic modulus of the yogurt is increased in both the 70:30 casein-to-whey case and the 60:40 casein-to-whey case when the milk yogurt undergoes CO₂ treatment, indicating an improved yogurt texture.

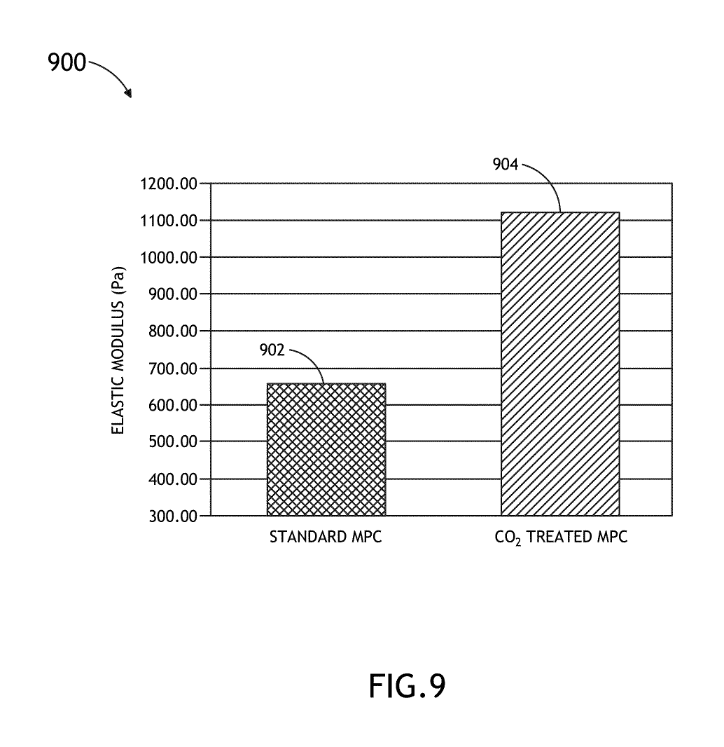

In another embodiment, yogurts, such as Greek yogurts, may be manufactured using yogurt milk standardized to a protein content of 2.0 to 7.5% of natural casein protein to whey protein. In addition, the natural untreated casein in the milk may be replaced with carbon dioxide treated casein, as described previously herein, in the range of 10 to 70 replacement. FIG. 9 illustrates the effects of varying milk protein treatments, as noted above. Column 902 represents a control treatment, wherein the yogurt milk does not undergo CO₂ treatment, and is standardized using untreated or standard milk protein concentrate. In contrast, column 904 represents the elastic modulus of Greek-style yogurt manufactured by standardizing the milk using the CO₂ treated milk protein concentrate. As can be seen, the treated yogurt displays a significant improvement increase in elastic modulus, which is indicative of improved texture.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A method for improving yogurt texture in a yogurt manufacture process comprising:
providing a volume of milk;
injecting carbon dioxide (CO₂) at a selected injection pressure into at least a portion of the provided volume of milk to establish a selected pH level in the provided volume of milk;
storing the CO₂-injected portion of the milk at a selected temperature for a selected time period;
forming a retentate by applying a filtration process to the CO₂-injected portion of the milk;
mixing at least a portion of the retentate with a volume of non-treated milk to form a mixture of retentate and non-treated milk in one or more selected proportions; and
forming a yogurt product with at least a portion of the mixture of retentate and non-treated milk.

2. The method of claim 1, wherein the forming a yogurt product with at least a portion of the mixture of retentate and non-treated milk comprises:
heat treating at least a portion of the mixture of retentate and non-treated milk by heating the mixture to a selected temperature for a selected time; and
cooling the heated mixture of retentate and non-treated milk to a temperature suitable to establish at least one of an incubation process or a fermentation process in the mixture of retentate and non-treated milk.

3. The method of claim 2, further comprising:
upon cooling of the mixture of retentate and non-treated milk, performing an acidification process on the mixture of retentate and non-treated milk to form the yogurt product.

4. The method of claim 3, wherein the performing an acidification process on the mixture of retentate and non-treated milk to form the yogurt product comprises:
performing an acidification process on the mixture of retentate and non-treated milk to form the yogurt product with at least one of one or more bacterial cultures or one or more chemical acidulates.

5. The method of claim 1, wherein the providing a volume of milk comprises:
providing a volume of milk having at least one of an initial pH level, a selected protein content or a selected temperature.

6. The method of claim 1, wherein the filtration process comprises:
a membrane filtration process.

7. The method of claim 1, wherein the filtration process comprises:
a filtration process suitable for achieving a protein concentration in the retentate that is 2-7 times larger than the protein concentration of the provided milk.

8. The method of claim 1, wherein the retentate comprises:
a functional milk protein (FMP) concentrate.

9. The method of claim 1, wherein the retentate comprises:
a treated milk protein concentrate (T-MPC).

10. The method of claim 1, wherein the mixing at least a portion of the retentate with a volume of non-treated milk to form a mixture of retentate and non-treated milk in one or more selected proportions comprises:
mixing at least a portion of the retentate with a volume of non-treated milk to form a mixture of retentate and non-treated milk in one or more selected proportions such that 10-70% of the milk protein in the non-treated milk is replaced with retentate.

11. The method of claim 1, further comprising:
drying the retentate formed by the filtration process in order to form a retentate powder.

12. The method of claim 1, wherein the forming a yogurt product with at least a portion of the mixture of retentate and non-treated milk comprises:
forming set yogurt with at least a portion of the mixture of retentate and non-treated milk.

13. The method of claim 1, wherein the forming a yogurt product with at least a portion of the mixture of retentate and non-treated milk comprises:
forming stirred yogurt with at least a portion of the mixture of retentate and non-treated milk.

14. The method of claim 1, wherein the forming a yogurt product with at least a portion of the mixture of retentate and non-treated milk comprises:
forming Greek yogurt with at least a portion of the mixture of retentate and non-treated milk.

15. The method of claim 1, further comprising:
standardizing protein content of an additional volume of milk to a selected protein content level using a portion of the mixture of retentate and non-treated milk.

16. The method of claim 15, wherein the standardizing protein content of an additional volume of milk to a selected protein content level using a portion of the mixture of retentate and non-treated milk comprises:
standardizing protein content of an additional volume of milk to a selected protein content level by replacing a portion of natural untreated casein of the additional volume of milk with a portion of the mixture of retentate and non-treated milk.

17. A method for improving yogurt texture in a yogurt manufacture process comprising:
providing a volume of milk;
injecting carbon dioxide (CO₂) at a selected injection pressure into at least a portion of the provided volume of milk to establish a selected pH level in the provided volume of milk;
storing the CO₂-injected portion of the milk at a selected temperature for a selected time period;
mixing the CO₂-injected portion of the milk with a volume of non-treated milk to form a mixture of the CO₂-injected milk and non-treated milk in one or more selected proportions; and
forming a yogurt product with at least a portion of the mixture of the CO₂-injected milk and non-treated milk.

18. The method of claim 17, wherein the forming a yogurt product with at least a portion of the mixture of the CO₂-injected milk and non-treated milk comprises:
heat treating at least a portion of the mixture of the CO₂-injected milk and the non-treated milk by heating the mixture to a selected temperature for a selected time; and
cooling the heated mixture of the CO₂-injected milk and the non-treated milk to a temperature suitable to establish at least one of an incubation process or a fermentation process in the mixture of the CO₂-injected milk.

19. The method of claim 18, further comprising:
upon cooling of the mixture of the CO₂-injected milk, performing an acidification process on the mixture of the CO₂-injected milk to form the yogurt product.

20. The method of claim 19, wherein the performing an acidification process on the mixture of the CO₂-injected milk to form the yogurt product comprises:
performing an acidification process on the mixture of the CO₂-injected milk to form the yogurt product with at least one of one or more bacterial cultures or one or more chemical acidulates.

21. The method of claim 19, wherein the forming a yogurt product with at least a portion of the mixture of the CO₂-injected milk and non-treated milk comprises:
forming set yogurt with at least a portion of the mixture of the CO₂-injected milk and non-treated milk.

22. The method of claim 19, wherein the forming a yogurt product with at least a portion of the mixture of the CO₂-injected milk and non-treated milk comprises:
forming stirred yogurt with at least a portion of the mixture of the CO₂-injected milk and non-treated milk.

23. The method of claim 19, wherein the forming a yogurt product with at least a portion of the mixture of the CO₂-injected milk and non-treated milk comprises:
forming Greek yogurt with at least a portion of the mixture of the CO₂-injected milk and non-treated milk.

24. A method for improving yogurt texture in a yogurt manufacture process comprising:
providing a volume of milk;
injecting carbon dioxide (CO₂) at a selected injection pressure into at least a portion of the provided volume of milk to establish a selected pH level;
storing the CO₂-injected portion of the milk at a selected temperature for a selected time period;
forming a retentate by applying a filtration process to the CO₂-injected portion of the milk; and
forming a yogurt product with at least a portion of the retentate.

25. The method of claim 24, wherein the forming a yogurt product with at least a portion of the retentate comprises:
heat treating at least a portion of the retentate; and
cooling the retentate to a temperature suitable to establish at least one of an incubation process or a fermentation process in the retentate.

26. The method of claim 25, further comprising:
upon cooling of the retentate, performing an acidification process on the retentate.

27. The method of claim 26, wherein the performing an acidification process on the retentate comprises:
performing an acidification process on the retentate to form the yogurt product with at least one of one or more bacterial cultures or one or more chemical acidulates.

28. The method of claim 24, wherein the forming a yogurt product with at least a portion of the retentate comprises:
forming set yogurt with at least a portion of the retentate.

29. The method of claim 24, wherein the forming a yogurt product with at least a portion of the retentate comprises:
forming stirred yogurt with at least a portion of the retentate.

30. The method of claim 24, wherein the forming a yogurt product with at least a portion of the retentate comprises:
forming Greek yogurt with at least a portion of the retentate.

31. A method for improving yogurt texture in a yogurt manufacture process comprising:
providing a volume of milk;
injecting carbon dioxide (CO₂) at a selected injection pressure into at least a portion of the provided volume of milk; and
applying a filtration process to the at least a portion of the provided volume of milk during the injection of carbon dioxide into the at least a portion of the provided volume of milk to form retentate.

32. The method of claim 31, further comprising:
mixing at least a portion of the retentate with a volume of non-treated milk to form a mixture of retentate and non-treated milk in one or more selected proportions.

33. The method of claim 32, further comprising:
forming a yogurt product with at least a portion of the mixture of retentate and non-treated milk.

34. The method of claim 31, wherein the carbon dioxide is continuously injected into the provided volume of milk during the applied filtration process.

35. The method of claim 31, wherein the carbon dioxide is injected into the provided volume of milk during the applied filtration process at periodic intervals.

36.-43. (canceled)
